(19) United States
(12) Patent Application Publication
(10) Pub. No.: US 2006/0011224 A1
(43) Pub. Date: Jan. 19, 2006

(54) EXTRUSION FREE WET CLEANING PROCESS

(76) Inventor: Chung-Chih Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/710,522

(22) Filed: Jul. 18, 2004

(51) Int. Cl. B08B 3/00

(52) U.S. Cl. 134/137; 134/2

(57) ABSTRACT

A wafer wet cleaning system includes a wet cleaning tool for performing a wafer cleaning process and a light inhibiting means for preventing a wafer to be cleaned from light exposure during wafer cleaning operations.

### BACKGROUND OF INVENTION

1. Field of the Invention

The present invention relates to an improved wet cleaning approach to back-end of line (BEOL) processes. More particularly, the present invention relates to an improved wet cleaning process incorporated with a light inhibition means for post-etch copper structures, particularly, for copper-dual damascene structures.

2. Description of the Prior Art

As the density of semiconductor devices increases, the demands on interconnect layers for connecting the semiconductor devices to each other also increases. Therefore, there is a desire to switch from the traditional aluminum metal interconnects to copper interconnects. Unfortunately, suitable copper etches for a semiconductor fabrication environment are not readily available. To overcome the copper etch problem, damascene processes have been developed. The copper damascene processes ordinarily involve the use of chemical mechanical polishing.

Typically, after the damascene process, the wafer is subjected to wet clean for removing particles, polymer residuals, or photoresist in the form of either bench wet clean or single-wafer clean. Wet clean processes are frequently used in the back end during the fabrication of integrated circuit chips. Chipmakers have used essentially the same wet cleaning process and chemistry for over 30 years, since chips had ten-micron geometries. But as features shrink to the nanometer scale and the number of cleaning steps increases, a faster, more efficient clean process is vital to achieving the high yields and productivity required for 300 mm device manufacturing.

One approach typically used to clean copper structures after via/trench dry etch is using a very diluted aqueous HF-based cleaning process. An alternative approach featuring its effectiveness, which was developed by Mattson Technology Wet Process Division (Exton, Pa.) and United Microelectronics Corp. (Hsinchu, Taiwan), includes a two-step process based on the diluted HF-based cleaning process. The first step of the two-step process is a mild oxidation step consisting of a dilute H₂O₂ solution 36:1 and a surfactant with megasonics irradiation. This step removes some polymer residues and the sputtered Cu on the sidewalls of the vias and trenches, and oxidizes the copper surface. The first step can be used without a surfactant. The second step is a mild oxide etch utilizing dilute HF, NH₄F or NH₂OH. This step undercuts the polymer residues and removes both leftover sputtered copper from the sidewalls, and oxide, such as CuO and Cu(OH)₂, from the copper surface.

One problem associated with the above-described backend wet clean process is that the exposed copper metal on the wafer is prone to extruding due to reduction of cupric ions that exists in the aqueous solution in the wet process sinks. This problem has been addressed in the pending U.S. patent application Ser. No. 09/682,054, filed Jul. 16, 2001 entitled “Extrusion-Free Wet Cleaning Process For Copper-Dual Damascene Structures” by Wu, assigned to the same party as the present application. Wu teaches using means for preventing copper reduction reactions on the exposed copper wiring line. The copper reduction preventing means may be increasing the pH of the acidic cupric oxide cleaning solution to above 7.

### SUMMARY OF INVENTION

The primary object of the present invention is to provide an extrusion free wet cleaning process for wafer cleaning.

According to the claimed invention, a wafer wet cleaning system is provided. The wafer wet cleaning system includes a wet cleaning tool for performing a wafer cleaning process and a light inhibiting means for preventing a wafer to be cleaned from light exposure during the wafer cleaning process.

From one aspect of the present invention, an extrusion-free wet cleaning process is proposed. The extrusion-free wet cleaning process includes at least the following steps:

(1) Providing a wet cleaning tool.

(2) Preparing a wafer having a main surface comprising at least one exposed copper feature and a dielectric film.

(3) Transferring the wafer into the wet cleaning tool in a light inhibited manner.

(4) Cleaning the main surface of the wafer by contacting a cleaning solution in the aforesaid light inhibited manner so as to avoid photo-induced electrochemical reactions.

Other objects, advantages and novel features of the invention will become more clearly and readily apparent from the following detailed description when taken in conjunction with the accompanying drawings.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 illustrates a post-etch dual damascene structure formed on a silicon substrate/wafer; and

FIG. 2 is a schematic diagram showing a wafer wet cleaning system in accordance with one preferred embodiment of the present invention.

### DETAILED DESCRIPTION

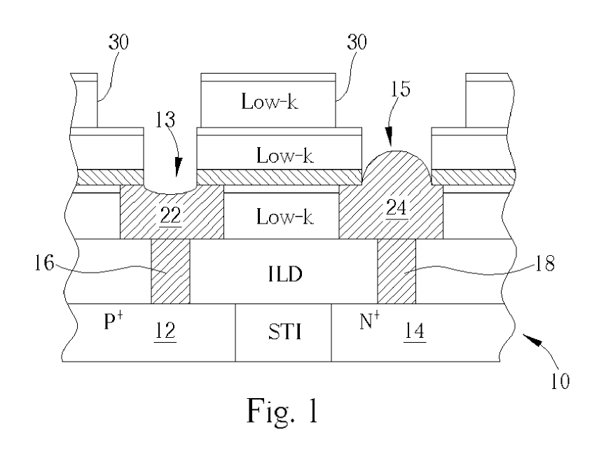

Please refer to FIG. 1. FIG. 1 illustrates a post-etch dual damascene structure 30 formed on a silicon substrate/wafer 10, in an acidic ambient, such as aqueous HF solution, the lift CuOₓ and/or Cu(OH)₂ molecules dissolve and thus produce massive copper ions (Cu²⁺) in the solution. The dual damascene structure 30 is formed by employing Cu metal and low-k dielectrics system. Some exemplary low-k materials include FLARE™, SiLK™ and BCB (porous dielectrics), but not limited thereto. In FIG. 1, the silicon substrate/wafer 10 is dunk into an acidic oxide etch solution for a certain time period, a recess 13 formed due to the Cu loss is observed at a top surface of a first level metal, Cu wiring line 22 which is electrically connected with a P⁺ diffusion region 12 of the silicon substrate 10 via a tungsten plug 16. In the meantime, an undesirable extrusion 15 is formed atop an adjacent Cu wiring line 24 which is electrically connected with a N⁺ diffusion (electron-rich) region 12 of the silicon substrate 10 via a tungsten plug 18.

A reasonable explanation for this phenomenon is that the P-N junction fabricated in the silicon substrate 10 provides an electrical path for electrochemical reactions. Excessive copper ions deposit on the anode (i.e. N⁺ region connected Cu wiring line) due to reduction reaction. In the reduction of cupric oxide the oxidation number of copper has changed from +2 to zero by the gain of two electrons. It is also believed that the aforesaid electrochemical reactions are induced by light exposure during the wet cleaning process.

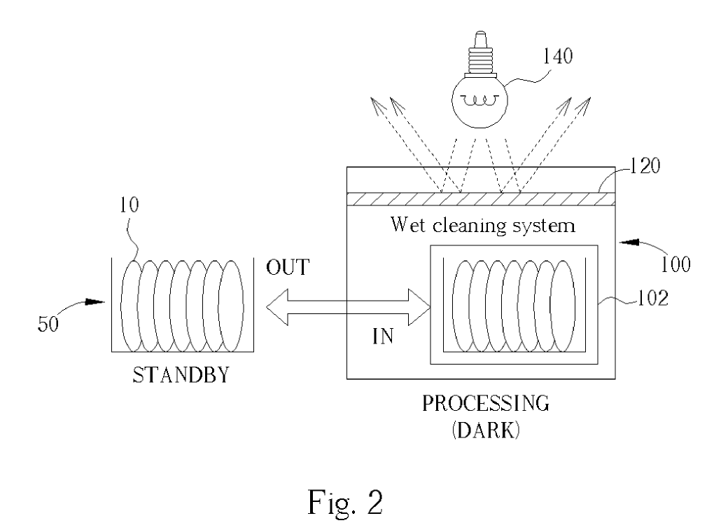

Please refer to FIG. 2. FIG. 2 is a schematic diagram showing a wafer wet cleaning system 100 in accordance with one preferred embodiment of the present invention. The wafer wet cleaning system 100 is employed to clean a batch of semiconductor wafers 10. Each of the semiconductor wafers 10 has a main surface comprising at least one exposed copper metal feature 22 or 24 as set forth in FIG. 1. In another embodiment, the wafer wet cleaning system 100 is employed to clean a single wafer at one time. Preferably, these semiconductor wafers 10 are initially carried in the form of a wafer lot 50, but not limited thereto. A mechanical lifting device or robotic arm (not shown) is ordinarily employed to move the wafer lot 50 into or out of the wafer wet cleaning system 100.

According to this invention, the wafer wet cleaning system 100 comprises a wafer cleaning tool 102 and a light inhibition means 120 for preventing the wafer cleaning tool 102 from light exposure. The light may be emanated from a light source 140 which may be natural light or a lamp for illumination purposes. According to the preferred embodiment, the wafer cleaning tool 102 comprises a succession of sinks for containing aqueous chemicals or clean solution such as diluted HF, acids, surfactants, or de-ionized water, etc. The wafer cleaning tool 102 may further comprises a wet scrubber and/or megasonic agitation tools. In another embodiment, the wafer cleaning tool 102 is a single-wafer cleaning tool such as an Oasis system available from Applied Materials, Inc. or the like.

The present invention features the light inhibition means 120 that prevents a wafer to be cleaned from light exposure during the wet cleaning process, thereby suppressing the above-described photo-induced electrochemical reactions. By doing this, the undesired copper extrusion phenomenon may be completely eliminated. According to one preferred embodiment, the light inhibition means 120 may be a sheet of aluminum foil that is disposed between the light source 140 and the wafer cleaning tool 102. The aluminum foil is cheap and readily available. However, other like materials may be used. The wafer cleaning tool 102 may be covered by the aluminum foil to create a dark environment. In one case that the light source is a lamp for illumination purposes, the lamp may be turned off during the wet cleaning operations.

The present invention also provides an extrusion-free wet cleaning process. The extrusion-free wet cleaning process includes the following steps:

(1) Providing a wet cleaning tool (single-wafer type or batch-type).

(2) Preparing a wafer having a main surface comprising at least one exposed copper feature and a dielectric film (similar to the structure set forth in FIG. 1).

(3) Transferring the wafer into the wet cleaning tool in a light inhibited manner.

(4) Cleaning the main surface of the wafer by contacting a cleaning solution in the aforesaid light inhibited manner so as to avoid photo-induced electrochemical reactions.

Those skilled in the art will readily observe that numerous modification and alterations of the invention may be made while retaining the teachings of the invention. Accordingly, the above disclosure should be construed as limited only by the metes and bounds of the appended claims.

What is claimed is:

1. An extrusion-free wet cleaning process, comprising:
providing a wet cleaning tool;
preparing a wafer having a main surface comprising at least one exposed copper feature and a dielectric film;
transferring said wafer into said wet cleaning tool in a light inhibited manner; and
cleaning said main surface of said wafer by contacting a cleaning solution in said light inhibited manner.

2. The extrusion-free wet cleaning process according to claim 1 wherein said wafer is a semiconductor wafer.

3. The extrusion-free wet cleaning process according to claim 1 wherein said exposed copper feature is damascened into said dielectric film.

4. The extrusion-free wet cleaning process according to claim 1 wherein during said cleaning step of said main surface of said wafer in said light inhibited manner, said wafer is not exposed to light.

5. The extrusion-free wet cleaning process according to claim 1 wherein said wet cleaning tool comprises a succession of sinks containing said cleaning solution.

6. The extrusion-free wet cleaning process according to claim 1 wherein said wet cleaning tool is a single-wafer cleaning tool.

7. A wafer wet cleaning system comprising a wet cleaning tool for performing a wafer cleaning process and a light inhibiting means for preventing a wafer to be cleaned from light exposure during said wafer cleaning process.

8. The wafer wet cleaning system according to claim 7 wherein said wet cleaning tool comprises a succession of sinks for containing cleaning solution.

9. The wafer wet cleaning system according to claim 7 wherein said wet cleaning tool is a single-wafer cleaning tool.

10. The wafer wet cleaning system according to claim 7 wherein said wafer has a main surface comprising at least one exposed copper feature and a dielectric film.

11. The extrusion free wet cleaning process according to claim 7 wherein said wafer is a semiconductor wafer.
